(19) United States
(12) Patent Application Publication
(10) Pub. No.: US 2025/0056293 A1
(43) Pub. Date: Feb. 13, 2025

(54) METHODS AND APPARATUSES FOR NETWORK ENERGY SAVING

(71) Applicant: SHARP KABUSHIKI KAISHA, Sakai City (JP)

(72) Inventors: PO-CHUN CHOU, Taipei (TW); YUNG-LAN TSENG, Taipei (TW); TZU-WEN CHANG, Taipei (TW); TZU-YUEH TSENG, Taipei (TW)

(21) Appl. No.: 18/798,554

(22) Filed: Aug. 8, 2024

Related U.S. Application Data
(60) Provisional application No. 63/532,217, filed on Aug. 11, 2023.

(51) Int. Cl. H04W 24/10; H04W 52/02; H04W 72/232

(52) U.S. Cl. CPC H04W 24/10; H04W 52/0235; H04W 72/232

(57) ABSTRACT

A method for a User Equipment (UE) for enhancement in Network Energy Saving (NES) is provided. The method receives, from a Base Station (BS), a Radio Resource Control (RRC) message including a trigger state list and a Channel State Information (CSI) report configuration that includes one or more CSI report sub-configurations. The method receives, from the BS, a Downlink Control Information (DCI) format indicating a trigger state in the trigger state list. The trigger state is associated with the CSI report configuration and indicates a subset of CSI report sub-configurations in the one or more CSI report sub-configurations. The method then applies the subset of CSI report sub-configurations to perform a CSI reporting procedure on a Physical Uplink Shared Channel (PUSCH).

### CROSS-REFERENCE TO RELATED APPLICATION(S)

The present disclosure claims the benefit of and priority to U.S. Provisional Patent Application Ser. No. 63/532,217, filed on Aug. 11, 2023, entitled “METHOD AND APPARATUS FOR CSI REPORTING USED FOR NETWORK ENERGY SAVING,” the content of which is hereby incorporated herein fully by reference into the present application for all purposes.

### FIELD

The present disclosure is related to wireless communication and, more specifically, to methods and apparatuses for enhancement in Network Energy Saving (NES).

### BACKGROUND

Various efforts have been made to improve different aspects of wireless communication for the cellular wireless communication systems, such as the 5th Generation (5G) New Radio (NR) system, by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the art.

### SUMMARY

The present disclosure is related to methods and apparatuses for enhancement in Network Energy Saving (NES).

According to a first aspect of the present disclosure, a method performed by a User Equipment (UE) for enhancing Network Energy Saving (NES) is provided. The method includes receiving, from a Base Station (BS), a Radio Resource Control (RRC) message including a trigger state list and a Channel State Information (CSI) report configuration that includes one or more CSI report sub-configurations; receiving, from the BS, a Downlink Control Information (DCI) format indicating a trigger state in the trigger state list, where the trigger state is associated with the CSI report configuration and indicates a subset of CSI report sub-configurations in the one or more CSI report sub-configurations; and applying the subset of CSI report sub-configurations to perform a CSI reporting procedure on a Physical Uplink Shared Channel (PUSCH).

In some implementations of the first aspect of the present disclosure, the CSI report configuration is associated with one or more CSI Reference Signal (CSI-RS) resources and one or more CSI-RS antenna ports, and a CSI report sub-configuration in the subset of CSI report sub-configurations includes at least one of the following: a first field indicating a sub-configuration Identifier (ID), a second field indicating a subset of CSI-RS resources in the one or more CSI-RS resources that is configured for a channel measurement, or a third field indicating a subset of CSI-RS antenna ports in the one or more CSI-RS antenna ports.

In some implementations of the first aspect of the present disclosure, the third field includes a bit string and each bit in the bit string corresponds to a CSI-RS antenna port of the one or more CSI-RS antenna ports. The method further includes in response to determining that a bit in the bit string is set to a first value, enabling a CSI-RS antenna port that corresponds to the bit for calculating CSI in the CSI reporting procedure; and in response to determining that the bit in the bit string is set to a second value, disabling the CSI-RS antenna port corresponding to the bit for calculating the CSI in the CSI reporting procedure.

In some implementations of the first aspect of the present disclosure, the method further includes identifying the subset of CSI-RS antenna ports according to the third field by determining which bits in the bit string are set to the first value.

In some implementations of the first aspect of the present disclosure, the CSI report configuration further includes a first field indicating a report Identifier (ID) and a second field indicating the one or more CSI report sub-configurations.

In some implementations of the first aspect of the present disclosure, the CSI reporting procedure is one of an Aperiodic CSI (A-CSI) reporting procedure and a Semi-Persistent CSI (SP-CSI) reporting procedure.

According to a second aspect of the present disclosure, a User Equipment (UE) for enhancing Network Energy Saving (NES) is provided. The UE includes at least one processor and at least one non-transitory computer-readable medium coupled to the at least one processor. The at least one non-transitory computer-readable medium stores one or more computer-executable instructions that, when executed by the at least one processor, cause the UE to receive, from a Base Station (BS), a Radio Resource Control (RRC) message including a trigger state list and a Channel State Information (CSI) report configuration that includes one or more CSI report sub-configurations; receive, from the BS, a Downlink Control Information (DCI) format indicating a trigger state in the trigger state list, where the trigger state is associated with the CSI report configuration and indicates a subset of CSI report sub-configurations in the one or more CSI report sub-configurations; and apply the subset of CSI report sub-configurations to perform a CSI reporting procedure on a Physical Uplink Shared Channel (PUSCH).

In some implementations of the second aspect of the present disclosure, the CSI report configuration is associated with one or more CSI Reference Signal (CSI-RS) resources and one or more CSI-RS antenna ports, and a CSI report sub-configuration in the subset of CSI report sub-configurations includes at least one of the following: a first field indicating a sub-configuration Identifier (ID), a second field indicating a subset of CSI-RS resources in the one or more CSI-RS resources that is configured for a channel measurement, or a third field indicating a subset of CSI-RS antenna ports in the one or more CSI-RS antenna ports.

In some implementations of the second aspect of the present disclosure, the third field includes a bit string and each bit in the bit string corresponds to a CSI-RS antenna port of the one or more CSI-RS antenna ports. The one or more computer-executable instructions, when executed by the at least one processor, further cause the UE to in response to determining that a bit in the bit string is set to a first value, enable a CSI-RS antenna port corresponding to the bit for calculating CSI in the CSI reporting procedure; and in response to determining that the bit in the bit string is set to a second value, disable the CSI-RS antenna port corresponding to the bit for calculating the CSI in the CSI reporting procedure.

In some implementations of the second aspect of the present disclosure, the one or more computer-executable instructions, when executed by the at least one processor, further cause the UE to identify the subset of CSI-RS antenna ports according to the third field by determining which bits in the bit string are set to the first value.

In some implementations of the second aspect of the present disclosure, the CSI report configuration further includes a first field indicating a report Identifier (ID) and a second field indicating the one or more CSI report sub-configurations.

In some implementations of the second aspect of the present disclosure, the CSI reporting procedure is one of an Aperiodic CSI (A-CSI) reporting procedure and a Semi-Persistent CSI (SP-CSI) reporting procedure.

According to a third aspect of the present disclosure, a Base Station (BS) for enhancing Network Energy Saving (NES) is provided. The BS includes at least one processor and at least one non-transitory computer-readable medium coupled to the at least one processor. The at least one non-transitory computer-readable medium stores one or more computer-executable instructions that, when executed by the at least one processor, cause the BS to transmit, to a User Equipment (UE), a Radio Resource Control (RRC) message including a trigger state list and a Channel State Information (CSI) report configuration that includes one or more CSI report sub-configurations; and transmit, to the UE, a Downlink Control Information (DCI) format indicating a trigger state in the trigger state list, thereby enabling the UE to apply a subset of CSI report sub-configurations in the one or more CSI report sub-configurations to perform a CSI reporting procedure on a Physical Uplink Shared Channel (PUSCH), where the trigger state is associated with the CSI report configuration and indicates the subset of CSI report sub-configurations.

In some implementations of the third aspect of the present disclosure, the CSI report configuration is associated with one or more CSI Reference Signal (CSI-RS) resources and one or more CSI-RS antenna ports, and a CSI report sub-configuration in the subset of CSI report sub-configurations includes at least one of the following: a first field indicating a sub-configuration Identifier (ID), a second field indicating a subset of CSI-RS resources in the one or more CSI-RS resources that is configured for a channel measurement, or a third field indicating a subset of CSI-RS antenna ports in the one or more CSI-RS antenna ports.

In some implementations of the third aspect of the present disclosure, the third field includes a bit string and each bit in the bit string corresponds to a CSI-RS antenna port of the one or more CSI-RS antenna ports.

In some implementations of the third aspect of the present disclosure, the CSI report configuration further includes a first field indicating a report Identifier (ID) and a second field indicating the one or more CSI report sub-configurations.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a schematic diagram illustrating a format of an SP-CSI-reporting-on-PUCCH-Activation/Deactivation MAC CE, according to an example implementation of the present disclosure.

FIG. 2 is a flowchart illustrating a method/process for NES enhancement, according to an example implementation of the present disclosure.

FIG. 3 is a block diagram illustrating a node for wireless communication, according to an example implementation of the present disclosure.

### DESCRIPTION

Some of the abbreviations in the present application are defined as follows and, unless otherwise specified, the abbreviations have the following meanings:

| Abbreviation | Full name |
|---|---|
| 3GPP | 3^{rd} Generation Partnership Project |
| 5G | 5^{th} Generation |
| 5GC | 5G Core |
| ACK | Acknowledgement |
| AN-PDB | Access Network Packet Delay Budget |
| AS | Access Stratum |
| ASN.1 | Abstract Syntax Notation One |
| BFRQ | Beam Failure Recovery Request |
| BS | Base Station |
| BSR | Buffer Status Report |
| BWP | Bandwidth Part |
| C-RNTI | Cell Radio Network Temporary Identifier |
| CA | Carrier Aggregation |
| CAG | Closed Access Group |
| CB | Codebook-Based |
| CG | Configured Grant |
| CJT | Coherent Joint Transmission |
| CN | Core Network |
| CN-PDB | Core Network Packet Delay Budget |
| CORESET | Control Resource Set |
| CPE | Customer Premises Equipment |
| CRC | Cyclic Redundancy Check |
| CSI | Channel State Information |
| CSI-RS | Channel State Information Reference Signal |
| CS-RNTI | Configured Scheduling Radio Network |
| | Temporary Identifier |
| CSS | Common Search Space |
| CU | Central Unit |
| DAPS | Dual Active Protocol Stack |
| DC | Dual Connectivity |
| DCI | Downlink Control Information |
| DG | Dynamic Grant |
| DI | Delay Information |
| DL | Downlink |
| DL-SCH | Downlink Shared Channel |
| DMRS | Demodulation Reference Signal |
| DR | Delay Report |
| DRB | Data Radio Bearer |
| DTCH | Dedicated Traffic Channel |
| DU | Distributed Unit |
| ETSI | European Telecommunications Standards Institute |
| E-UTRA | Evolved Universal Terrestrial Radio Access |
| EN-DC | E-UTRA NR Dual Connectivity |
| EPC | Evolved Packet Core |
| eMBB | Enhanced Mobile BroadBand |
| eMTC | Enhanced Machine Type Communication |
| eNB | Evolved Node B |
| FDD | Frequency Division Duplexing |
| FR | Frequency Range |
| FR1 | Frequency Range 1 |
| FR2 | Frequency Range 2 |
| FWA | Fixed Wireless Access |
| GEO | Geostationary Equatorial Orbit |
| gNB | Next Generation Node B |
| GNSS | Global Navigation Satellite System |
| GW | Gateway |
| HARQ | Hybrid Automatic Repeat Request |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| ITU | International Telecommunication Union |
| L1 | Layer 1 |
| L2 | Layer 2 |
| L3 | Layer 3 |
| LAN | Local Area Network |
| LCH | Logical Channel |
| LCID | Logical Channel Identity |
| LEO | Low Earth Orbit |
| LTE | Long Term Evolution |
| LSB | Least Significant Bit |
| MAC | Medium Access Control |
| MAC CE | MAC Control Element |
| MCG | Master Cell Group |
| MCS | Modulation Coding Scheme |
| MIB | Master Information Block |
| MIMO | Multi-Input Multi-Output |
| mMTC | Massive Machine Type Communications |
| MN | Master Node |
| MTC | Machine Type Communication |
| NACK | Negative Acknowledgement |
| NAS | Non-Access Stratum |
| NB-IoT | Narrow Band Internet of Things |
| NCB | Non-Codebook-Based |
| NDI | New Data Indicator |
| NES | Network Energy Saving |
| NPN | Non-Public Network |
| NR | New Radio |
| NR-U | NR Unlicensed |
| NTN | Non-Terrestrial Network |
| PA | Power Amplifier |
| PBCH | Physical Broadcast Channel |
| PCell | Primary Cell |
| PCI | Physical Cell Identity |
| PDB | Packet Delay Budget |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical |
| PLMN | Public Land Mobile Network |
| PMI | Precoding Matrix indicator |
| PNI-NPN | Public Network Integrated Non-Public Network |
| PRACH | Physical Random Access Channel |
| PSDB | PDU Set Delay Budget |
| PUCCH | Physical Uplink Control Channel |
| PUSCH | Physical Uplink Shared Channel |
| QCL | Quasi-CoLocation |
| QoS | Quality of Service |
| RA | Random Access |
| RACH | Random Access Channel |
| RAN | Radio Access Network |
| RAR | Random Access Response |
| RAT | Radio Access Technology |
| RE | Resource Element |
| Rel-15 | Release 15 |
| RF | Radio Frequency |
| RLC | Radio Link Control |
| RS | Reference Signal |
| RLF | Radio Link Failure |
| RSTD | Reference Signal Time Difference Measurement |
| RNTI | Radio Network Temporary Identifier |
| RO | RACH Occasion |
| RRC | Radio Resource Control |
| RS | Reference Signal |
| RSRP | Reference Signal Received Power |
| RSRQ | Reference Signal Receiving Quality |
| RX | Reception |
| SCell | Secondary Cell |
| SCG | Secondary Cell Group |
| SDT | Small Data Transmission |
| SI | System Information |
| SIB | System Information Block |
| SL | Sidelink |
| SLIV | Start and Length Indicator Value |
| SN | Secondary Node |
| SNPN | Stand-alone Non-Public Network |
| SpCell | Special Cell |
| SR | Scheduling Request |
| SRB | Signaling Radio Bearer |
| SRS | Sounding Reference Signal |
| SRI | SRS Resource Indicator |
| SSB | Synchronization Signal Block |
| SSS | Secondary Synchronization Signal |
| SUL | Supplementary Uplink |
| TA | Timing Advance |
| TAG | Timing Advance Group |
| TAT | Time Alignment Timer |
| TB | Transport Block |
| TCI | Transmission Configuration Indication |
| TDD | Time Division Duplexing |
| TN | Terrestrial Network |
| TPC | Transmission Power Control |
| TPMI | Transmit Precoder Matrix Indication |
| TRP | Transmission Reception Point |
| TRS | Tracking Reference Signal |
| TRX | Transmission/Reception |
| TS | Technical Specification |
| TX | Transmission |
| UCI | Uplink Control Information |
| UE | User Equipment |
| UL | Uplink |
| UL-CG | Uplink-Configured Grant |
| UPF | User Plane Function |
| URLLC | Ultra-Reliable and Low-Latency Communications |
| USIM | Universal Subscriber Identity Module |
| USS | UE-specific Search Space |
| V2X | Vehicle-to-Everything |
| VSAT | Very Small Aperture Terminal |
| XR | Extended Reality |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic.

The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS may be operable to provide radio coverage to a specific geographical area using multiple cells forming the RAN. The BS may support the operations of the cells. Each cell may be operable to provide services to at least one UE within its radio coverage.

Each cell (often referred to as a serving cell) may provide services to serve one or more UEs within its radio coverage, such that each cell schedules the DL (and optionally UL resources) to at least one UE within its radio coverage for DL (and optionally UL packet transmissions from the UE). The BS may communicate with one or more UEs in the radio communication system via the plurality of cells.

A cell may allocate sidelink (SL) resources for supporting the Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As described above, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes may be considered for NR, specifically Low-Density Parity-Check (LDPC) code and Polar Code. The coding scheme adaption may be configured based on channel conditions and/or service applications.

At least the DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, or at least one of A and B.

In this disclosure, “X/Y” may encompass the meanings of “X or Y,” “X and Y,” and “X and/or Y,” as indicated by two or more of the sentences, paragraphs, sub-bullets, points, actions, behaviors, terms, alternatives, aspects, examples, embodiments, or claims described in the following invention(s).

One aspect of the present disclosure may be applied in various contexts, including communications, communication equipment (such as mobile telephone apparatus, base station apparatus, wireless LAN apparatus, and/or sensor devices), integrated circuits (such as communication chips), and software programs, among others.

The terms “an antenna port” and “antenna ports,” as discussed in the present disclosure, may refer to “an antenna port used for transmission of PUSCH(s)/PUCCH(s)” and “antenna ports used for transmission of PUSCH(s)/PUCCH(s),” respectively.

Some of the terms, definitions, and/or abbreviations included in the present disclosure may either be sourced from existing documents (such as those from ETSI, ITU, or other sources) or may be newly created by experts from the 3GPP whenever there was a need for a precise vocabulary.

Examples of some selected terms in the present disclosure are provided as follows.

Antenna Panel: A conceptual term for a UE antenna implementation. It may be assumed that a panel may be an operational unit for controlling a transmit spatial filter (beam). A panel may typically include multiple antenna elements. In some implementations, a beam may be formed by a panel, and in order to form two beams simultaneously, two panels may be needed. Such simultaneous beamforming by multiple panels may be subject to the UE capability. A similar definition for “panel” may be applicable by applying spatial receiving filtering characteristics.

Beam: A beam may include a spatial (domain) filtering. In one example, the spatial filtering may be applied in the analog domain by adjusting a phase and/or amplitude of the signal before being transmitted by a corresponding antenna element. In another example, the spatial filtering may be applied in the digital domain by the Multi-Input Multi-Output (MIMO) technique in the wireless communication system. For example, “a UE made a PUSCH transmission by using a specific beam” may mean that the UE made the PUSCH transmission by using the specific spatial/digital domain filter. The “beam” may also be, but is not limited to be, represented as an antenna, an antenna port, an antenna element, a group of antennas, a group of antenna ports, or a group of antenna elements. The beam may also be formed by a certain reference signal resource. In short, the beam may be equivalent to a spatial domain filter through which the EM wave is radiated. Beam information may include details about the selected or utilized beam or spatial filter. In some implementations, the individual beams (e.g., spatial filters) may be used to transmit individual reference signals. Consequently, a beam or beam information may be represented by one or more reference signal resource indices.

DCI: DCI may include downlink control information, and there may be various DCI formats used in a PDCCH. The DCI format may be a predefined format in which the downlink control information may be packed/formed and transmitted in a PDCCH.

TCI state: a TCI state may include parameters for configuring a QCL relationship between one or more DL reference signals and a target reference signal set. For example, a target reference signal set may be the DMRS ports of a PDSCH or a PDCCH.

HARQ: A functionality that ensures the delivery between peer entities at Layer 1 (e.g., Physical Layer). A single HARQ process may support one Transport Block (TB) when the physical layer is not configured for the downlink/uplink spatial multiplexing, and when the physical layer is configured for downlink/uplink spatial multiplexing, a single HARQ process may support one or more TBs. There may be one HARQ entity per serving cell. Each HARQ entity may support a parallel (number of) DL and UL HARQ process.

In the present disclosure, although the term “gNB” may have been used throughout the document, it should be understood that the term “gNB” may be replaced by any other type of BS (e.g., an eNB).

In recent decades, communication systems have evolved rapidly, driven by advances in the underlying technology. The evolution of the latest 5G NR system may be primarily focused on achieving three key objectives: enhanced Mobile Broadband (eMBB), Ultra-Reliable Low-Latency Communication (URLLC), and massive Machine-Type Communications (mMTC). However, the energy consumption required to achieve these goals may be substantial, both for the gNBs/NW and for the UEs.

Energy saving may have become a crucial issue for the NR systems, particularly for the gNBs/NW, due to the high energy consumption of the gNBs/NW. The energy saving for the gNBs/NW may also be referred to as Network Energy Saving (NES). A potential solution to address the challenge of high energy consumption may include enhancing the Channel State Information (CSI) reporting-related procedures (e.g., which may include measurement, reporting, and signaling). Such enhancements may aim to enable efficient adaptation of the spatial elements (such as antenna ports and physical antenna elements) and/or efficient adaptation of power offset values between the PDSCH and the CSI-RS.

The CSI framework may assist a gNB/NW in determining how to perform data transmission and/or control signaling by providing channel state information between the gNB/NW and a UE. The gNB/NW may configure the UE with resource information and resource set information used for transmitting the CSI-RS(s) via RRC signaling, where the RRC signaling may include a CSI measurement configuration, which may be represented by a particular IE, such as the IE (SI-MeasConfig. Based on the resource set information, the UE may confirm the resource type (e.g., aperiodic, semi-persistent, or periodic) of each resource set, according to the received RRC signaling (e.g., including the IE CSI-ResourceConfig), from the gNB/NW. The configuration of each CSI report may be provided to the UE through RRC signaling received from the gNB/NW, where the RRC signaling may include a CSI report configuration, which may be represented by a particular IE, such as the IE CSI-ReportConfig. The gNB/NW may trigger a CSI reporting instance by transmitting DCI/MAC CE signaling to the UE, where the CSI reporting instance may correspond to a triggering state configured by the gNB/NW via RRC signaling.

For CSI reporting, two aspects of reducing the energy consumption may be considered: spatial adaptation and power adaptation. Spatial adaptation aims to reduce the power consumption of the TRX chains and PAs by attempting to shut down more spatial elements. Specifically, the number of antenna ports/physical antenna elements used for the transmitted CSI-RS(s) may be flexibly adjusted (e.g., reduced). The adaptation of antenna ports may be referred to as Type I adaptation, while the adaptation of physical antenna elements may be referred to as Type II adaptation. An antenna port may be associated with one or more physical antenna elements. Therefore, shutting down an antenna port may also mean shutting down all the physical antenna elements associated with the antenna port. Conversely, with Type II adaptation, at least one of the physical antenna elements associated with the same antenna port may remain switched on. Power adaptation, on the other hand, may focus on reducing the transmission power/power spectrum density or increasing the PA efficiency by adjusting power offset values between the PDSCH and the CSI-RS. Different mechanisms for CSI reporting based on the spatial adaptation and/or power adaptation are provided in more detail as follows.

### Resource Setting Configuration

A UE may be configured with one or more CSI-RS resources by RRC signaling received from a serving gNB/NW/BS/cell, where the RRC signaling may include a measurement configuration, which may be represented by a particular IE, such as the IE MeasConfig. The configured CSI-RS resource(s) may include a Non-Zero-Power (NZP) CSI-RS resource (which may correspond to a particular IE, such as the IE NZP-(SI-RS-Resource). The NZP CSI-RS resource may be used to configure the NZP CSI-RS in the cell, where the corresponding IE (e.g., the IE NZP-(SI-RS-Resource) is included. Each configured CSI-RS resource may be associated with one or more CSI-RS resource sets (which may correspond to a particular IE, such as the IE NZP-(SI-RS-ResourceSet), where all the CSI-RS resources within the same CSI-RS resource set may have identical time properties (e.g., such as the offset between the slot containing the DCI triggering a set of aperiodic NZP CSI-RS resources and the slot in which the CSI-RS resource set is transmitted).

The gNB/NW may also configure the UE with a group of one or more CSI-RS resource sets via RRC signaling, where the RRC signaling may include a CSI resource configuration, which may be represented by a particular IE, such as the IE CSI-ResourceConfig. All CSI-RS resource set(s) within the group may have the same resource type (e.g., aperiodic, semi-persistent, or periodic). Moreover, the gNB/NW may assign a dedicated ID (e.g., the field CSI-ReportConfigId in the IE (SI-ResourceConfig) for each group to identify the different groups. The IE CSI-ResourceConfig may be considered to be used for channel measurement and/or in other determinations.

In some implementations, the number of antenna ports configured in all CSI-RS resources within the same CSI-RS resource set may be identical (e.g., as per a typical behavior in 3GPP R-15/R-16/R-17 technical specifications).

In some implementations, a UE may be configured with one or more CSI-RS resource sets applicable to the NES by RRC signaling received from a gNB/NW (e.g., from the serving RAN). In this case, each CSI-RS resource within the same CSI-RS resource set may have only one spatial adaptation pattern, respectively. The spatial adaptation pattern of the CSI-RS resource may be related to a particular field, such as the field resourceMapping within the corresponding IE NZP-CSI-RS-Resource. A configuration, in which each CSI-RS resource within a CSI-RS resource set may only be configured with one spatial adaptation pattern, may be referred to as an A1-1 configuration in the present disclosure.

In some implementations, if the A1-1 configuration for Type II spatial adaptation is used, all CSI-RS resources within the configured CSI-RS resource set may use the same number of antenna ports to transmit the corresponding CSI-RS. However, the physical antenna element subset corresponding to each CSI-RS resource within the configured CSI-RS resource set may differ. For example, the first antenna port corresponding to the first CSI-RS resource within the CSI-RS resource set may be associated with four physical antenna elements, while the second antenna port corresponding to the second CSI-RS resource within the same set may be associated with only one physical antenna element. The order of CSI-RS resources may be determined based on the corresponding IDs (e.g., the IE NZP-(SI-RS-ResourceSetId) of the CSI-RS resources, and the antenna ports used for CSI-RS may start from 3000.

In some implementations, if the A1-1 configuration for Type II spatial adaptation is used, all CSI-RS resources within the CSI-RS resource set may overlap in the frequency domain, but not in the time domain. For example, the frequency domain allocation field, such as the field frequencyDomainAllocation of a particular IE (e.g., the IE (SI-RS-ResourceMapping) for all CSI-RS resources within the CSI-RS resource set may be configured with the same value, while the field of the first OFDM symbol in the time domain (e.g., the field firstOFDMSymbolInTimeDomain) of the IE CSI-RS-ResourceMapping may be different for each resource. For the time-invariant channels, the UE may transmit a CSI report to the gNB/NW after measuring the reception of the corresponding CSI-RSs. The CSI report may help the gNB/NW transmit data with minimum energy consumption and acceptable performance.

In some implementations, if the A1-1 configuration for Type II spatial adaptation is used, all CSI-RS resources that overlap in the time domain within the CSI-RS resource set may not overlap in the frequency domain. The gNB/NW may configure the UE with the overlapping CSI-RS resources occupying different RBs in the same time occasion via RRC signaling (e.g., using particular fields, such as the field frequencyDomainAllocation, the field density, and/or the field freqBand of the IE (SI-RS-ResourceMapping). After measuring the received corresponding CSI-RSs, the UE may transmit a CSI report to the gNB/NW. The CSI report may assist the gNB/NW in transmitting data with minimum energy consumption while maintaining an acceptable performance.

In some implementations, if the A1-1 configuration for Type II spatial adaptation is used, all the CSI-RS resources within the CSI-RS resource set may be divided into multiple groups, with CSI-RS resources in the different groups used in pairs. A pair of CSI-RS resources may be indicated by an index. For example, if two groups are considered, the first group may correspond to the CSI-RS resources that have all physical antenna elements, while the second group may correspond to the CSI-RS resources that have fewer physical antenna elements (e.g., a subset of all the physical antenna elements in the first group). In other words, a pair of CSI-RS resources may include a CSI-RS resource without Type II adaptation and a CSI-RS resource with Type II adaptation. The UE may transmit a CSI report to the gNB/NW after measuring the received corresponding CSI-RSs. The CSI report may help the gNB/NW to transmit data with minimum/lower energy consumption (e.g., in the case of transmitting the data on a resource corresponding to a CSI-RS resource that uses a subset of all physical antenna elements) and an acceptable performance (e.g., in the case that the BLER is smaller than a configured threshold).

In some implementations, if the A1-1 configuration for Type II spatial adaptation is used, the number of antenna ports of CSI-RS resources within the CSI-RS resource set may be different. In some implementations, a UE may be configured with one or more CSI-RS resource sets applicable to the NES by the RRC signaling received from a gNB/NW, where each CSI-RS resource within the same CSI-RS resource set may have one or more spatial adaptation patterns. The spatial adaptation pattern of the CSI-RS resource may be related to a resource mapping filed (e.g., the field resourceMapping) within the corresponding IE NZP-CSI-RS-Resource. A configuration, in which each CSI-RS resource within a CSI-RS resource set is configured with one or more spatial adaptation patterns, may be referred to as an A1-2 configuration in the present disclosure.

In some implementations, if the A1-2 configuration for Type I spatial adaptation is used, each CSI-RS resource within the configured CSI-RS resource set may be configured with one or more spatial adaptation patterns, each spatial adaptation pattern corresponding to a different number of antenna ports used to transmit the corresponding CSI-RS. Each spatial adaption pattern may be related to a sub-configuration within the CSI-RS resource configuration.

In some implementations, if the A1-2 configuration for Type I spatial adaptation is used, the sub-configuration related to a spatial adaptation pattern may be a field included in the corresponding IE NZP-CSI-RS-Resource, regarded as a different resource mapping than the field resourceMapping within the same IE NZP-CSI-RS-Resource. The sub-configuration may include information related to (or associated with) the number of antenna ports used for transmitting the CSI-RS(s). For example, the IE related to the sub-configuration may include a field (e.g., the field nrofPorts) related to the number of antenna ports, where the number of antenna ports configured in the sub-configuration within the IE NZP-(SI-RS-Resource may be less than the number of antenna ports configured in the same IE NZP-(SI-RS-Resource. The number of antenna ports configured in the sub-configuration within the IE NZP-CSI-RS-Resource may be represented as an explicit value (e.g., in an ENUMERATED format) or as a differential value. For example, the differential value may represent a value relative to the number of antenna ports configured in the same IE NZP-CSI-RS-Resource (e.g., in INTEGER format).

In some implementations, if the A1-2 configuration for Type I spatial adaptation is used, the sub-configuration related to a spatial adaptation pattern may be included in the corresponding IE CSI-RS-ResourceMapping associated with the field resourceMapping within the IE NZP-CSI-RS-Resource. The IE CSI-RS-ResourceMapping with the sub-configuration may be associated with one or more CSI-RS resources used for the CSI-RS transmission. The sub-configuration may typically include information about the number of antenna ports used for the CSI-RS transmission.

In some implementations, if the A1-2 configuration for Type I spatial adaptation is used, each sub-configuration may include a dedicated ID for identification purposes. For example, the dedicated ID may be a local ID used in the configured IE NZP-(SI-RS-Resource. The dedicated ID may be used to identify the corresponding sub-configuration provided in a CSI-RS resource configuration when the CSI-RS resource configuration is triggered/activated.

In some implementations, if the A1-2 configuration for Type I spatial adaptation is used, all CSI-RS resources associated with the same IE NZP-CSI-RS-Resource may overlap in the frequency domain, but not in the time domain, or vice versa. To achieve this, the gNB/NW may configure the UE with sub-configurations including different settings within the same IE NZP-CSI-RS-Resource. Each sub-configuration may include information about the time domain allocation (e.g., the field firstOFDMSymbolInTimeDomain), the frequency domain allocation (e.g., the field frequencyDomainAllocation and/or the field freqBand), and the number of antenna ports (e.g., the field nrofPorts) of the corresponding CSI-RS resource.

In some implementations, in the A1-2 configuration for Type I spatial adaptation, the configured sub-configuration may include one or more fields. Each of the one or more fields may be set to a differential value relative to the corresponding field in the IE CSI-RS-ResourceMapping within the same IE NZP-CSI-RS-Resource. For example, if a time domain assignment field exists in the sub-configuration, the time domain assignment field may be set to a differential value relative to the value of the field firstOFDMSymbolInTimeDomain within the same IE NZP-CSI-RS-Resource.

In some implementations, each of the one or more fields may be set to a value referring to the corresponding field in the IE (SI-RS-ResourceMapping within the same IE NZP-CSI-RS-Resource. For example, if a time domain assignment field exists in the sub-configuration, the time domain assignment field may be set to a value referring to the field firstOFDMSymbolInTimeDomain within the same IE NZP-CSI-RS-Resource, where the value may be used directly to indicate the time domain allocation.

In some implementations, a subset of fields in a sub-configuration may be set to differential values relative to the corresponding field in the IE (SI-RS-ResourceMapping within the same IE NZP-(SI-RS-Resource. The remaining fields in the same sub-configuration may be set to values directly referring to the corresponding field in the IE (SI-RS-ResourceMapping within the same IE NZP-(SI-RS-Resource.

In some implementations, a UE may be configured with one or more CSI-RS resource sets applicable to the NES by RRC signaling received from a gNB/NW. In such a case, each CSI-RS resource within the same CSI-RS resource set may have one or more power adaptation patterns. The power adaptation pattern of the CSI-RS resource may be related to a particular field, such as the field powerControlOffset and/or the field powerControlOffsetSS, within the corresponding IE NZP-(SI-RS-Resource. The field powerControlOffset may represent the power offset of a PDSCH RE to an NZP CSI-RS RE, while the field powerControlOffsetSS may represent the power offset of an NZP CSI-RS RE to an SSS RE. A configuration, in which each CSI-RS resource within a CSI-RS resource set is configured with more power adaptation pattern, may be referred to as the A1-2-power configuration in the present disclosure.

In some implementations, when a UE is configured with an A1-2 configuration, Type I adaptation, and an A1-2-power configuration via RRC signaling received from the gNB/NW, each sub-configuration may include at least one spatial adaptation pattern and/or one power adaptation pattern. For example, a sub-configuration may include a field related to the number of antenna ports used for spatial adaptation and another field related to the power offset used for power adaptation.

In some implementations, each power adaptation pattern corresponding to the same configured CSI-RS resource may be included in a dedicated sub-configuration within the IE NZP-CSI-RS-Resource.

In some implementations, when the UE is configured with the A1-2 configuration, the Type I adaption, and the A1-2-power configuration via the RRC signaling received from the gNB/NW, each field corresponding to a power adaptation pattern within the same configured CSI-RS resource may be set to a differential value. For example, the differential value may represent a power offset value relative to the value of the field powerControlOffset/powerControlOffsetSS within the same IE NZP-CSI-RS-Resource.

In some implementations, when the UE is configured with the A1-2 configuration, the Type I adaption, and the A1-2-power configuration via the RRC signaling received from the gNB/NW, each field corresponding to a power adaptation pattern within the same configured CSI-RS resource may be set to a direct value within the same IE NZP-CSI-RS-Resource.

In some implementations, a UE may be configured with one or more CSI-RS resource sets applicable to NES by RRC signaling received from a gNB/NW. In this case, each CSI-RS resource within the same CSI-RS resource set may have a different power offset value (e.g., the field power ControlOffset). A configuration, in which each CSI-RS resource within a CSI-RS resource set is configured with different or the same power offset value(s), may be referred to as the A1-1-power configuration in the present disclosure.

In some implementations, when the UE is configured with the A1-1 configuration, the Type II adaptation, and the A1-1-power configuration via RRC signaling received from the gNB/NW, the field(s) powerControlOffset powerControlOffsetSS from different CSI-RS resources within the same CSI-RS resource set may have the same or different values.

In some implementations, a UE may be configured with one or more CSI-RS resource sets applicable to the NES through RRC signaling received from a gNB/NW. In such a case, each CSI-RS resource within the same CSI-RS resource set may belong to the same or different CSI-RS resource groups. Moreover, the UE may be configured with one or two CSI-RS resource groups in a CSI-RS resource set through the RRC signaling received from the gNB/NW, with the maximum number of configurable CSI-RS resource groups being dependent on the reported UE capability.

In some implementations, the gNB/NW may configure the UE with two CSI-RS resource groups in a CSI-RS resource set via RRC signaling that includes a dedicated IE within the corresponding IE NZP-CSI-RS-ResourceSet. The dedicated IE may provide information about the number of CSI-RS resources in each group and/or the association of each pair of CSI-RS resources. In a pair, one CSI-RS resource may come from a first group, and the other CSI-RS resource may come from a second group. A pair of CSI-RS resources may be established by identifying and linking two specific CSI-RS resource IDs, where the linked CSI-RS resources belong to two distinct CSI-RS resource groups.

In some implementations, the UE may report the CSI report associated with a pair of CSI-RS resources from different groups. The CSI report may include content associated with both CSI-RS resources. For example, the first part of the CSI report may be associated with the first CSI-RS resource, while the second part of the CSI report may be associated with the second CSI-RS resource. In other words, the UE may report the content associated with a pair of CSI-RS resources in a single CSI report.

### Report Setting Configuration

A UE may be configured with a CSI report configuration through RRC signaling (e.g., including the IE CSI-ReportConfig) received from a gNB/NW. A CSI report configuration may include, at least, a dedicated ID (e.g., the field report ConfigId) to identify the different CSI reports, a field to associate the CSI report with a CSI-RS resource group (e.g., the field resourcesForChannelMeasurement) used for channel measurement, a field to indicate the time domain behavior of the CSI report (e.g., the field reportConfigType), a field to indicate the CSI report related quantities (e.g., the field reportQuantity), a field to indicate the time domain behavior of the of the CSI report (e.g., the field reportFreqConfig), and/or a field related to a codebook configuration (e.g., the field codebookConfig).

In some implementations, a UE may be configured with one or more CSI report configurations applicable to the NES through RRC signaling received from a gNB/NW, where each CSI report configurations may include one or more report sub-configurations. Moreover, each report sub-configuration may correspond to at least one CSI report in at least one CSI reporting instance. A configuration, in which each CSI report configuration is configured with multiple report sub-configurations, may be referred to as an A2-2 configuration in the present disclosure.

In some implementations, if the UE is configured with the A2-2 configuration, the Type I adaptation, and the A1-2 configuration, all CSI-RS resource(s) in the CSI-RS resource set for channel measurement may be associated with each sub-configuration provided in a CSI report configuration. In addition, each sub-configuration provided in a CSI-RS resource configuration may be associated with a sub-configuration provided in the CSI report configuration. The number of sub-configurations provided in the CSI report configuration may be, but is not limited to be, the same as the number of sub-configurations provided in a CSI-RS Resource configuration.

In some implementations, when the UE is configured with the A2-2 configuration, the Type I adaptation, and the A1-2 configuration, all sub-configuration(s) provided in a CSI report configuration may be associated with a common codebook configuration (e.g., the IE codebookConfig). The common codebook configuration may include a Type I codebook configuration or a Type II codebook configuration. Moreover, the Type I codebook may be used for the Single-User MIMO (SU-MIMO) scenario, while the Type II codebook may be used for the Multi-User MIMO (MU-MIMO) scenario.

It should be noted that a sub-configuration in a CSI report configuration may also be referred to as a report sub-configuration or a CSI report sub-configuration in the present disclosure. That is, the terms “sub-configuration,” “report sub-configuration,” and “CSI report sub-configuration” may be utilized interchangeably in the present disclosure.

In some implementations, when the UE is configured with the A2-2 configuration, the Type I adaptation, and the A1-2 configuration, the codebook sub-type corresponding to each sub-configuration provided in a CSI report configuration may be different. A codebook sub-type may include, but is not limited to, a “type1-SinglePanel” or a “type1-MultiPanel.” For example, if the UE is configured with a CSI report configuration with multiple sub-configurations and all the sub-configurations are associated with the common codebook configuration being set to “Type I,” the codebook subtypes of some of the sub-configurations may be set to “type1-SinglePanel” and the codebook subtypes of the others may be set to “type1-MultiPanel”.

In some implementations, when the UE is configured with the A2-2 configuration, the Type I adaptation, and the A1-2 configuration, the codebook sub-type corresponding to each sub-configuration provided in a CSI report configuration may be the same. A codebook sub-type may include, but is not limited to, a “type1-SinglePanel” or a “type1-MultiPanel.” For example, if the UE is configured with a CSI report configuration with multiple sub-configurations and all the sub-configurations are associated with the common codebook configuration being set to “Type I,” the codebook subtypes of all the sub-configurations may be set to “type1-SinglePanel”.

In some implementations, when the UE is configured with the A2-2 configuration, the Type I adaptation, and the A1-2 configuration, each sub-configuration provided in a CSI report configuration may include one CSI-RS port subset from the configured CSI-RS ports, where the CSI-RS port subset may satisfy the corresponding codebook configuration. For example, if the number of the configured CSI-RS ports is sixteen and the (N₁,N₂) pair is equal to (8,1), one CSI-RS port subset may have eight CSI-RS ports with a (N₁,N₂) pair of (4,1), where N₁ is the number of antenna ports in the first dimension and N₂ is the number of antenna ports in the second dimension.

In some implementations, when the UE is configured with the A2-2 configuration, the Type I adaptation, and the A1-2 configuration, the number of the configured CSI-RS ports related to the sub-configuration provided in a CSI report configuration may be the same as the number of the configured CSI-RS ports related to the associated sub-configuration provided in the CSI-RS resource.

In some implementations, when the UE is configured with the A2-2 configuration, the Type I adaptation, and the A1-2 configuration, the sub-configuration provided in a CSI report configuration may be associated with the corresponding sub-configuration provided in the CSI-RS resource configuration by following the configuration order. For example, the first configured sub-configuration provided in the CSI report configuration may be associated with (or linked to) the first configured sub-configuration provided in the CSI-RS resource configuration.

In some implementations, when the UE is configured with the A2-2 configuration, the Type I adaptation, and the A1-2 configuration, the sub-configuration provided in a CSI report configuration may be associated with the corresponding sub-configuration provided in the CSI-RS resource configuration by indicating the corresponding sub-configuration ID. For example, the sub-configuration provided in the CSI reporting configuration may include a field that is set to an ID associated with the corresponding sub-configuration provided in the CSI-RS resource configuration.

In some implementations, when the UE is configured with the A2-2 configuration, the Type I adaptation, and the A1-2 configuration, a sub-configuration provided in a CSI report configuration may include a dedicated ID that is used to identify a sub-configuration provided in the CSI report configuration. In some implementations, the dedicated ID may be a local ID used in the configured IE (SI-ReportConfig. For example, a dedicated ID may be used to identify the corresponding sub-configuration provided in a CSI report configuration when the CSI report configuration is triggered/activated.

In some implementations, each sub-configuration provided in a CSI report configuration may be associated with the same report quantity (e.g., the field reportQuantity), where the report quantity may be related to the corresponding CSI content. For example, the report quantity may be configured to take on various values, including but not limited to cri-RI-PMI-CQI and cri-RI-i1. Moreover, the field indicating the common report quantity may be provided in the corresponding IE CSI-ReportConfig.

In some implementations, each sub-configuration provided in a CSI report configuration may be associated with a dedicated report quantity, where each dedicated report quantity may be different. For example, the report quantity corresponding to the first sub-configuration provided in the CSI report configuration may be set to the value of “cri-RI-PMI-CQI” and the report quantity corresponding to the second sub-configuration provided in the CSI report configuration may be set to the value of “cri-RI-i1.” Moreover, the field indicated the dedicated report quantity may be in the corresponding sub-configuration provided in a CSI report configuration.

In some implementations, when the UE is configured with the A2-2 configuration, the Type I adaptation, and the A1-2 configuration, each sub-configuration provided in a CSI report configuration may be associated with the same Channel Quality Indicator (CQI) format (e.g., the field cqi-FormatIndicator). For example, the CQI format associated with all sub-configurations provided in the CSI report configuration may be set to “wideband” so that all CSI reports associated with the same CSI report configuration may have a common wideband CQI for the entire reporting band. Moreover, the field indicating the common CQI format may be provided in the corresponding IE CSI-ReportConfig.

In some implementations, each sub-configuration provided in a CSI report configuration may be associated with a CQI format. Each dedicated CQI format may be different. For example, the CQI format corresponding to the first sub-configuration provided in the CSI report configuration may be set to “wideband” and the CQI format corresponding to the second sub-configuration provided in the CSI report configuration may be set to “subband.” Moreover, the field indicating the dedicated CQI format may be provided in the corresponding sub-configuration provided in a CSI report configuration.

In some implementations, when the UE is configured with the A2-2 configuration, the Type I adaptation, and the A1-2 configuration, each sub-configuration provided in a CSI report configuration may be associated with the same PMI format (e.g., the field cqi-FormatIndicator). For example, the PMI format associated with all sub-configurations provided in the CSI report configuration may be set to “wideband,” so that all CSI reports associated with the same CSI report configuration may have a common wideband PMI for the entire reporting band. In some implementations, the field indicating the common PMI format may be provided in the corresponding IE CSI-ReportConfig. In some implementations, the field indicating the common PMI format may include the IE (SI-ReportConfig, which may be configured by the serving RAN for the UE to report CSI-RS measurement report while the serving RAN is operating on the NES mode).

In some implementations, each sub-configuration provided in a CSI report configuration may be associated with a PMI format, where each dedicated PMI format may differ. For example, the PMI format corresponding to the first sub-configuration provided in the CSI report configuration may be set to “wideband” and the PMI format corresponding to the second sub-configuration provided in the CSI report configuration may be set to “subband.” Moreover, the field indicating the dedicated PMI format may be in the corresponding sub-configuration provided in a CSI report configuration.

In some implementations, when the UE is configured with the A2-2 configuration, the Type II adaptation, and the A1-1 configuration, one or more CSI-RS resources in the CSI-RS resource set for channel measurement may be associated with the same sub-configuration provided in a CSI report configuration.

In some implementations, when the UE is configured with the A2-2 configuration, the Type II adaptation, and the A1-1 configuration, each sub-configuration provided in a CSI report configuration may include a CSI-RS resource list that includes one or more CSI-RS resource IDs associated with the corresponding sub-configuration provided in the CSI report. In addition, each CSI-RS resource associated with the list in the sub-configuration within the same configuration may be included in the same CSI-RS resource set.

In some implementations, when the UE is configured with the A2-2 configuration, the Type II adaptation, and the A1-1 configuration, all sub-configuration(s) provided in a CSI report configuration may be associated with a common codebook configuration (e.g., the IE codebookConfig), where the common codebook configuration may include a Type I codebook configuration or a Type II codebook configuration. Moreover, the Type I codebook may be used for the SU-MIMO scenario and the Type II codebook may be used for the MU-MIMO scenario.

In some implementations, when the UE is configured with the A2-2 configuration, the Type II adaptation, and the A1-1 configuration, the codebook sub-type corresponding to each sub-configuration provided in a CSI report configuration may be the same. A codebook sub-type may include, but is not limited to, “type1-SinglePanel” or “type1-MultiPanel.” For example, if the UE is configured with a CSI report configuration with multiple sub-configurations and all the sub-configurations are associated with the common codebook configuration being set to “Type I,” the codebook subtypes of all sub-configurations may be set to “type1-SinglePanel.”

In some implementations, when the UE is configured with the A2-2 configuration, the Type II adaptation, and the A1-1 configuration, the codebook sub-type corresponding to each sub-configuration provided in a CSI report configuration may differ. A codebook sub-type may include, but is not limited to, “type1-SinglePanel” or “type1-MultiPanel.” For example, if the UE is configured with a CSI report configuration with multiple sub-configurations and all the sub-configurations are associated with the common codebook configuration being set to “Type I,” the codebook subtypes of some sub-configurations may be set to “type1-SinglePanel” and the codebook subtypes of others may be set to “type1-MultiPanel.”

In some implementations, when the UE is configured with the A2-2 configuration, the Type II adaptation, and the A1-1 configuration, one or more sub-configurations provided in a CSI report configuration may be associated with the Type I codebook configuration, while other sub-configurations provided in the CSI report configuration may be associated with the Type II codebook configuration. Moreover, the Type I codebook may be used for the SU-MIMO scenario and the Type II codebook may be used for the MU-MIMO scenario. For example, each sub-configuration provided in the CSI report configuration may include a field to set the dedicated codebook configuration.

In some implementations, when the UE is configured with the A2-2 configuration, the Type II adaptation, and the A1-1 configuration, each sub-configuration provided in a CSI report configuration may be associated with the same CQI format (e.g., the field cqi-FormatIndicator). For example, the CQI format associated with all sub-configurations provided in the CSI report configuration may be set to “wideband” so that all CSI reports associated with the same CSI report configuration may have a common wideband CQI for the entire reporting band. Moreover, the field indicating the common CQI format may be in the corresponding IE CSI-ReportConfig.

In some implementations, when the UE is configured with the A2-2 configuration, the Type II adaptation, and the A1-1 configuration, each sub-configuration provided in a CSI report configuration may be associated with the same PMI format (e.g., the field cqi-FormatIndicator). For example, the PMI format associated with all sub-configurations provided in the CSI report configuration may be set to “wideband” so that all CSI reports associated with the same CSI report configuration may have a common wideband PMI for the entire reporting band. Moreover, the field indicating the common PMI format may be in the corresponding IE CSI-ReportConfig.

In some implementations, when the UE is configured with the A2-2 configuration, the Type II adaptation, and the A1-1 configuration, a sub-configuration provided in a CSI report configuration may include a dedicated ID that is used to identify a sub-configuration provided in the CSI report configuration.

### Triggering/Activation of CSI Reports and CSI-RS

A UE may be configured with the configuration (or CSI report configuration) of one or more CSI reports by RRC signaling (e.g., the IE CSI-ReportConfig) received from a gNB/NW, where each CSI report may have a different time domain behavior. The behavior of the CSI report transmission in the time domain may be categorized as periodic, semi-persistent, or aperiodic. In addition, the time domain behavior of CSI report transmission may be identified by setting a report configuration type field (e.g., the field report ConfigType) in the corresponding IE CSI-ReportConfig.

The behavior of Aperiodic-CSI (A-CSI) reporting may correspond to the scenario in which a UE transmits a one-shot CSI report in response to the DCI signaling received from a gNB/NW, according to the CSI report configuration(s). The behavior of Periodic-CSI (P-CSI) reporting may correspond to a scenario in which a UE transmits the P-CSI report(s) if the UE is configured with the CSI report configuration(s). In the case of P-CSI reporting, the UE may autonomously transmit the P-CSI report(s) based on a relevant configuration without receiving additional triggering (e.g., DCI signaling or a MAC CE) from the gNB/NW. The behavior of Semi-Persistent CSI (SP-CSI) reporting may correspond to a scenario in which a UE transmits the SP-CSI report(s) in response to the DCI signaling or a MAC CE received from a gNB/NW, according to the CSI report configuration(s). The A-CSI or SP-CSI report triggered by the DCI signaling may be transmitted on a PUSCH. On the other hand, the SP-CSI report triggered by a MAC CE and the P-CSI report may be transmitted on a PUCCH.

For A-CSI reporting, the UE may be configured with a trigger state list through RRC signaling (e.g., the IE Aperiodic TriggerStateList) received from the gNB/NW. The trigger state list may include one or more trigger states (e.g., the IE CSI-Aperiodic TriggerState). Each trigger state may include one or more associated report configuration information elements (e.g., including the IE CSI-AssociatedReportConfigInfo). Moreover, each associated report configuration information element may be associated with a CSI report configuration ID (e.g., the IE CSI-ReportConfigId). When the NZP-CSI-RS within the associated report configuration information element is selected for channel measurement, the corresponding NZP-CSI-RS resource set may be indicated by the field resource Set. The UE may be requested to report the A-CSI report in response to receiving the DCI signaling, which may include the CSI request field, from the gNB/NW.

The CSI request field may indicate a trigger state from the configured trigger state list. In a case that the number of trigger states in the configured trigger state list is greater than the number that may be represented by the CSI request field, the UE may be indicated to filter the trigger states from the trigger state list in response to the MAC CE (e.g., the aperiodic CSI trigger state sub-selection MAC CE) received from the gNB/NW.

For SP-CSI reporting on a PUSCH, the UE may be configured with a trigger state list through RRC signaling (e.g., the IE (SI-SemiPersistentOnPUSCH-TriggerStateList) received from the gNB/NW. The trigger state may include one or more trigger states (e.g., the IE CSI-SemiPersistentOnPUSCH-TriggerState). Each trigger state may include an associated report configuration information element (e.g., specifying the field associatedReportConfigInfo). The associated report configuration information element may be associated with a CSI report configuration ID (e.g., the IE CSI-ReportConfigId). The UE may be requested to report an SP-CSI report in response to receiving DCI signaling, which may include a CSI request field, from the gNB/NW. The CSI request field may indicate a trigger state from the configured trigger state list.

In some implementations, when the UE is configured with the A2-2 configuration by RRC signaling received from the gNB/NW, a CSI report configuration may include L sub-configurations, where N sub-configurations of L sub-configurations may be triggered/activated by DCI signaling/MAC CE. It should be noted that 1≤N≤L.

In some implementations, when the UE is configured with the A2-2 configuration, a dedicated trigger state list used for A-CSI reporting and NES may be provided in a CSI measurement configuration (e.g., the IE CSI-Meas Congfig).

In some implementations, when the UE is configured with the A2-2 configuration and a trigger state list used for A-CSI reporting, the trigger state list may include one or more trigger states, where each trigger state may include one or more associated report configuration information elements. Each associated report configuration information element may be associated with a CSI report configuration or a sub-configuration provided in the CSI report configuration. All the associated report configuration information elements from the same trigger state may be related to the same CSI report configuration. For example, an associated report configuration information element from the same trigger state may be associated with a CSI report configuration ID (e.g., the IE CSI-ReportConfigID) provided in a CSI report configuration, and another associated report configuration information element from the same trigger state may be associated with the ID related to a sub-configuration provided in the same CSI report configuration.

In some implementations, when the UE is configured with the A2-2 configuration and a trigger state list used for A-CSI, all the associated report configuration information elements within the trigger state list may be associated with the same CSI report configuration.

In some implementations, when the UE is configured with the A2-2 configuration and a trigger state list used for A-CSI reporting, the trigger state list may include one or more trigger states, where each trigger state may include the same/different number of associated report configuration information elements. For example, a first trigger state from a trigger list may include L₁ associated report configuration information elements, and a second trigger state from the same trigger list may include L₂ associated report configuration information elements. In some implementations, even if each trigger state includes the same number of associated report configuration information elements, the associated report configuration information element set of each trigger state may be different.

In some implementations, when the UE is configured with the A2-2 configuration and a trigger state list used for A-CSI reporting, the UE may be requested to transmit the CSI report(s) used for the NES by DCI signaling (e.g., DCI format 0_1 or DCI format 0_2) received from the gNB/NW. The gNB/NW may use the CSI request field in the DCI signaling to indicate a trigger state from the configured trigger state list. The gNB/NW and the UE may perform a CSI framework according to the indicated trigger state. In some additional implementations, the UE may receive and interpret a DCI format (e.g., DCI format 0_1 or DCI format 0_2) in different approaches/methods/rules, which may depend on whether the serving RAN/serving cell is implementing the NES or not.

In some implementations, when the UE is configured with the A2-2 configuration and a trigger state list used for A-CSI reporting, the UE may be configured with the bitwidth of the CSI request by RRC signaling (e.g., the field reportTriggerSize or the reportTriggerSizeDCI-0-2) received from the gNB/NW. The configured bitwidth may restrict the maximum number that may be represented by the CSI request field. When the number of trigger states in the configured trigger state list is greater than the maximum number that may be represented by the CSI request field, the UE may be assigned a subset of the trigger states from the configured trigger state list by a MAC CE (e.g., the aperiodic CSI trigger state sub-selection MAC CE) received from the gNB/NW.

In some implementations, when the UE is configured with A2-2 configuration a trigger state list used for A-CSI, a dedicated MAC CE used for assigning a subset of the trigger states from the configured trigger state list may be sent from the gNB/NW to the UE.

In some implementations, when the UE is configured with the A2-2 configuration, a dedicated trigger state list used for the SP-CSI reporting on a PUSCH and the NES may be provided in the configured IE CSI-MeasCongfig.

In some implementations, when the UE is configured with the A2-2 configuration and a trigger state list used for SP-CSI reporting on a PUSCH, the trigger state list may include one or more trigger states. Each trigger state may include one associated report configuration information element. Each associated report configuration information element may be associated with a CSI report configuration or a sub-configuration provided in a CSI report configuration. All the associated report configuration information elements from the same trigger list may be related to the same CSI report configuration. For example, the associated report configuration information element within the first trigger state of the trigger state list may be associated with the IE CSI-ReportConfigID provided in a CSI report configuration, and the associated report configuration information within the second trigger state of the same trigger state list may be the ID related to a sub-configuration provided in the same CSI report configuration.

In some implementations, when the UE is configured with the A2-2 configuration and a trigger state list used for SP-CSI reporting on a PUSCH, the trigger state list may include one or more trigger states. Each trigger state may include one or more associated report configuration information elements. Each associated report configuration information element may be associated with at least one CSI report configuration or at least one sub-configuration provided in a CSI report configuration. Each associated report configuration information element from the same trigger list may be related to a different CSI report configuration. For example, the associated report configuration information element within the first trigger state of the trigger state list may be associated with the IE CSI-ReportConfigID provided in the first CSI report configuration, and the associated report configuration information within the second trigger state of the same trigger state list may be the ID related to a sub-configuration provided in the second CSI report configuration.

In some implementations, when the UE is configured with the A2-2 configuration and a trigger state list used for SP-CSI reporting on a PUSCH, the trigger state list may include one or more trigger states. Each trigger state may include one or more associated report configuration information elements. Each associated report configuration information element may be associated with a CSI report configuration or a sub-configuration provided in a CSI report configuration. All the associated report configuration information elements from the same trigger state may be related to the same CSI report configuration. For example, an associated report configuration information element from the same trigger state may be associated with the IE CSI-ReportConfigID provided in a CSI report configuration, and another associated report configuration information element from the same trigger state may be associated with the ID related to a sub-configuration provided in the same CSI report configuration.

In some implementations, when the UE is configured with the A2-2 configuration and a trigger state list used for SP-CSI reporting on a PUSCH, the trigger state list may include one or more trigger states. Each trigger state may include the same/different number of associated report configuration information elements. For example, the first trigger state of a trigger list may include L₁ associated report configuration information elements, and the second trigger state of the same trigger list may include L₂ associated report configuration information elements. In some implementations, even if each trigger state includes the same number of associated report configuration information elements, the associated report configuration information element set of each trigger state may be different.

In some implementations, when the UE is configured with the A2-2 configuration and a trigger state list used for SP-CSI reporting on a PUSCH, the trigger state list may include one or more trigger states. Each trigger state may include one or more associated report configuration information elements, where each associated report configuration information element may be associated with a different sub-configuration provided in the same CSI report configuration. An associated report configuration information element may be associated with the CSI report configuration (e.g., the IE CSI-ReportConfigID).

In some implementations, when the UE is configured with the A2-2 configuration and a trigger state list used for SP-CSI reporting on a PUSCH, the UE may be requested to transmit the CSI report(s) used for NES by DCI signaling (e.g., DCI format 0_1 or DCI format 0_2) received from the gNB/NW. The gNB/NW may use the CSI request field in the DCI signaling to indicate a trigger state from the configured trigger state list. The gNB/NW and the UE may perform a CSI framework according to the indicated trigger state.

In some implementations, when the UE is configured with the A2-2 configuration, the UE may be activated to perform the SP-CSI reporting on a PUCCH in response to a MAC CE received from the gNB/NW, where N of L sub-configurations provided in a CSI report configuration may be activated at once.

In some implementations, when the UE is configured with the A2-2 configuration, the UE may be activated to perform the SP-CSI reporting on a PUCCH in response to a dedicated MAC CE received from the gNB/NW. The dedicated MAC CE may include, at least, the field LCID, the field Serving Cell ID, the BWP ID, the field CSI Report ID, and the field St. The dedicated MAC CE may be identified by a MAC CE subheader with the LCID, the field Serving Cell ID may indicate the identity of the Serving Cell for which the MAC CE applies, the BWP ID may indicate a UL BWP for which the MAC CE applies, the field CSI Report ID may indicate a CSI report configuration for which the MAC CE applies, and the field Sᵢ may include the sub-configuration provided in the indicated CSI report configuration which includes the PUCCH resources for the SP-CSI reporting in the indicated BWP and has the i-th lowest ID.

The Sᵢ field may be set to “1” to indicate that the corresponding sub-configuration provided in the indicated CSI report configuration may be activated. The Sᵢ field may be set to “O” to indicate that the corresponding sub-configuration provided in the indicated CSI report configuration may be deactivated (or not activated). The indicated CSI report configuration may be assumed to be activated when any Sᵢ field is set to “1,” otherwise the indicated CSI report configuration may be assumed to be deactivated (or not activated).

In some implementations, when the UE is configured with the A2-2 configuration, the UE may be activated to perform the SP-CSI reporting on a PUCCH in response to an extended MAC CE (e.g., an extended SP-CSI-reporting-on-PUCCH-Activation/Deactivation MAC CE) received from the gNB/NW.

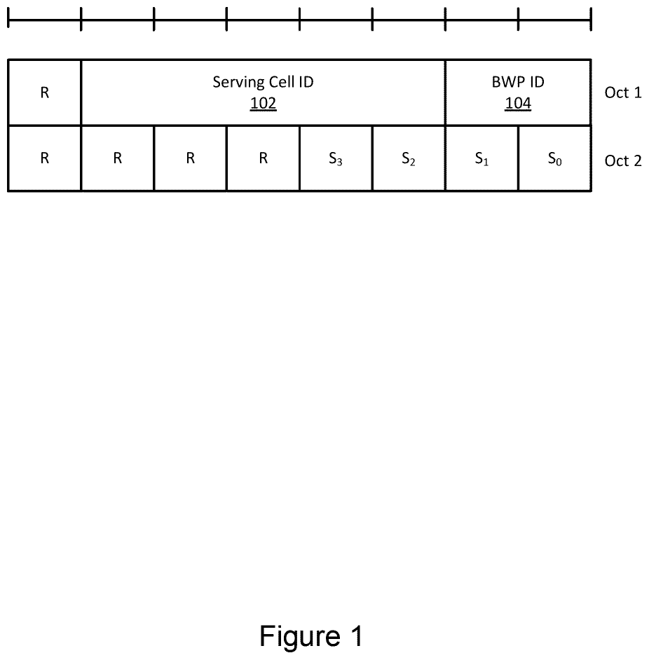

FIG. 1 is a schematic diagram illustrating a format of an SP-CSI-reporting-on-PUCCH-Activation/Deactivation MAC CE, according to an example implementation of the present disclosure.

As illustrated in FIG. 1, the SP-CSI-reporting-on-PUCCH-Activation/Deactivation MAC CE (e.g., MAC CE 100) may include Serving Cell ID field 102 that indicates the identity of the Serving Cell for which the MAC CE applies, BWP ID filed 104 that indicates a UL BWP for which the MAC CE applies, and several Sᵢ fields (e.g., S₀ to S₃). Each Sᵢ field may include a corresponding report configuration that includes the PUCCH resources for the SP-CSI reporting in the UL BWP indicated by BWP ID field 104 and has the i-th lowest (SI-ReportConfigId. Each R field in MAC CE 100 may refer to a reserved bit. The Sᵢ field may be set to a first value (e.g., “1”) to indicate that the corresponding sub-configuration provided in the indicated CSI report configuration is activated. The Sᵢ field may be set to a second value (e.g., “0”) to indicate that the corresponding sub-configuration provided in the indicated CSI report configuration is deactivated (or not activated).

An extended version of MAC CE 100 (which may also be referred to as an extended SP-CSI-reporting-on-PUCCH-Activation/Deactivation MAC CE) may use the reserved bit(s) to indicate one or more sub-configurations provided in the indicated CSI report configuration. In such a case, only one CSI report configuration may be activated. For example, when (1) S₀ is set to “1,” (2) the reserved bit corresponding to the first lowest sub-configuration ID is set to “1,” and (3) the reserved bit corresponding to the second lowest sub-configuration ID is set to “1,” the CSI report configuration with the lowest (SI-ReportConfigId and the sub-configuration with the first lowest sub-configuration ID provided in the indicated CSI report configuration (with the lowest CSI-ReportConfigId) and the sub-configuration with the second lowest sub-configuration ID provided in the indicated CSI report configuration (with the lowest CSI-ReportConfigId) may be activated.

### Priority, Dropping, and Multiplexing Rules

Under the CSI framework, all CSI reports sent by a UE may be configured/scheduled by a gNB/NW via DCI/MAC CE/RRC signaling. Each CSI report may be associated with a priority value Pri_{iCSI}(y,k,c,s)=2·N_{cells}·Mₛ·y+N_{cells}·Mₛ·k+Mₛ·c+s where:
y=0 for A-CSI reports to be carried on PUSCH y=1 for SP-CSI reports to be carried on PUSCH, y=2 for SP-CSI reports to be carried on PUCCH and y=3 for P-CSI reports to be carried on PUCCH,
k=0 for CSI reports carrying L1-RSRP or L1-SINR and k=1 for CSI reports not carrying L1-RSRP or L1-SINR,
c is the serving cell index and N_{cells} is the value of the higher layer parameter maxNrofServing Cells, and
s is the reportConfigID and Mₛ is the value of the higher layer parameter maxNrofCSI-ReportConfigurations.

A CSI report may be considered to have higher priority over another if its associated priority value (e.g., Pri_{iCSI}(y,k,c,s)) is lower. Collisions between the CSI reports may occur when the time occupancy of the scheduled physical channels of the CSI reports overlap in at least one OFDM symbol and transmitted on the same carrier. When a UE is configured to transmit two colliding CSI reports with different y values, the CSI report with the higher Pri_{iCSI} (y,k,c,s) value should not be sent by the UE, except when one y value is 2 and the other y values is 3. If the y values are the same, the two CSI reports may be multiplexed, or one may be dropped based on their priority values.

In some implementations, when the UE is configured with the A2-2 configuration, each sub-configuration ID provided in the CSI report configuration may be associated with an s value, where the s value may be greater than the report ConfigID of the CSI report configuration. For example, the s value associated with a sub-configuration provided in the CSI report configuration may be reportConfigID+the sub-configuration ID. The CSI report corresponding to the CSI report configuration may serve as the baseline for the CSI report corresponding to the sub-configuration provided in the CSI report configuration. Therefore, the priority value of the CSI report corresponding to the CSI report configuration may be smaller than the priority value of the CSI report corresponding to the sub-configuration provided in the CSI report configuration.

In some implementations, when the UE is configured with the A2-2 configuration, each sub-configuration ID provided in the CSI report configuration may be associated with an s value where the s value may be smaller than the report ConfigID of the CSI report configuration. For example, the s value associated with a sub-configuration provided in the CSI report configuration may be report ConfigID—the sub-configuration ID. Therefore, the priority value of the CSI report corresponding to the CSI report configuration may be greater than the priority value of the CSI report corresponding to the sub-configuration provided in the CSI report configuration.

In some implementations, when the UE is configured with the A2-2 configuration and multiple CSI reports are be multiplexed, a prioritization mechanism may be applied. The CSI may be selectively dropped, starting with the higher Pri_{iCSI} (y,k,c,s) until the code rate is less than, or equal to, the maximum code rate (e.g., the IE max CodeRate).

In some implementations, when the UE is reconfigured from an NES mode to a non-NES mode or vice versa (e.g., via RRC signaling received from the gNB/NW), the UE may drop the previously received lower-layer signaling (e.g., the MAC CE and/or DCI signaling) used to trigger a CSI report instance that has not been performed yet. Such dropping may occur because the received lower-layer signaling corresponds to the previous mode. In some implementations, the control signaling dropping may be due to the processing time required for the control signaling reception/decoding (e.g., due to HARQ processing).

In some implementations, the NES mode may be identified by the UE through the reception of dedicated IE(s) including CSI measurement configuration information, triggering event information, CSI report configuration with one or more sub-configurations, and/or CSI resource configuration with one or more sub-configurations.

In some implementations, when the UE is configured with the A2-2 configuration and multiple CSI reports are multiplexed, the UCI bit sequence corresponding to the CSI reports may be ordered according to their priority values. For instance, the first part of the UCI bit sequence, starting from the LSB, may correspond to the CSI report with the lowest priority value. The second part, beginning from the end of the first part, may correspond to the CSI report with the second-lowest priority value, and so on.

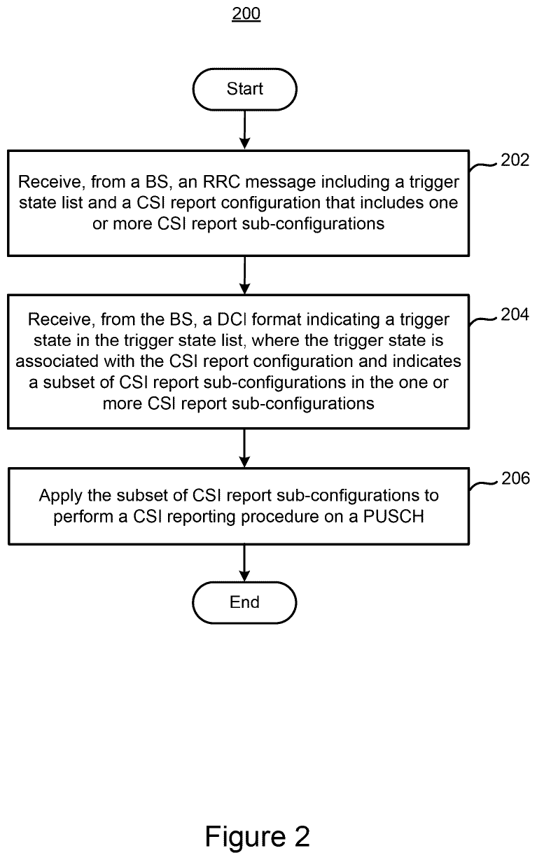

FIG. 2 is a flowchart illustrating method/process 200 for NES enhancement, according to an example implementation of the present disclosure. Although actions 202, 204, and 206 are illustrated, as separate actions, represented as independent blocks in FIG. 2, these separately illustrated actions should not be construed as to be necessarily order-dependent. The order in which the actions are performed in FIG. 2 is not intended to be construed as a limitation, and any number of the disclosed blocks may be combined in any order to implement the method, or an alternative method. Each of actions 202, 204, and 206 may be performed independent of the other actions, and may be omitted in some implementations of the present disclosure. Moreover, method/process 200 may be combined with other procedures/methods described in the present disclosure. Process 200 may be performed by a UE, with each action of process 200 corresponding to an operation executed by the UE.

In action 202, process 200 may start by receiving, from a BS, an RRC message including a trigger state list and a CSI report configuration that includes one or more CSI report sub-configurations.

In action 204, process 200 may receive, from the BS, a DCI format indicating a trigger state in the trigger state list, where the trigger state is associated with the CSI report configuration and indicates a subset of CSI report sub-configurations in the one or more CSI report sub-configurations. It should be noted that in the present disclosure, the term “subset” may include any number of elements from the original set, including all elements of the original set. For example, the total number of CSI report sub-configurations included in the subset indicated by the trigger state may be less than, or equal to, the total number of CSI report sub-configurations included in the CSI report configuration.

In action 206, process 200 may apply the subset of CSI report sub-configurations to perform a CSI reporting procedure on a PUSCH. Process 200 may then end.

In some implementations, the CSI report configuration may be associated with one or more CSI-RS resources and one or more CSI-RS antenna ports. A CSI report sub-configuration in the subset of CSI report sub-configurations may include at least one of the following: a first field indicating a sub-configuration ID, a second field indicating a subset of CSI-RS resources in the one or more CSI-RS resources that is configured for a channel measurement, or a third field indicating a subset of CSI-RS antenna ports in the one or more CSI-RS antenna ports.

In some implementations, the third field may include a bit string and each bit in the bit string corresponds to a CSI-RS antenna port of the one or more CSI-RS antenna ports. In response to determining that a bit in the bit string is set to a first value, the UE may enable a CSI-RS antenna port that corresponds to the bit for calculating CSI (e.g., CSI calculation) in the CSI reporting procedure. Additionally, in response to determining that the bit in the bit string is set to a second value, the UE may disable the CSI-RS antenna port corresponding to the bit for calculating the CSI in the CSI reporting procedure.

In some implementations, the UE may identify the subset of CSI-RS antenna ports according to the third field by determining which bits in the bit string are set to the first value.

In some implementations, the CSI report configuration may further include a field indicating a report ID and a field indicating the one or more CSI report sub-configurations.

In some implementations, the CSI reporting procedure may be one of an A-CSI reporting procedure and an SP-CSI reporting procedure.

The use of CSI report sub-configurations in process 200 may offer advantages in terms of energy efficiency and flexibility. By allowing the UE to use only a subset of the configured CSI-RS resources and/or CSI-RS antenna ports as indicated by the DCI format received from the BS, the system may achieve substantial power savings.

Additionally, by configuring multiple CSI report sub-configurations but only activating a subset as needed, the system may reduce the signaling overhead that would be required to frequently reconfigure CSI reporting parameters. This not only saves energy but also improves the overall efficiency of the network's operation.

It should be noted that in the present disclosure, the BS may perform methods/actions corresponding to those performed by the UE. For example, the receiving actions performed by the UE may correspond to the transmitting/configuring actions of the BS; the transmitting actions performed by the UE may correspond to the receiving actions of the BS. That is, the BS and the UE may have reciprocally aligned roles in transmission and reception.

For example, consider process 200 from the BS's perspective: the BS may transmit, to a UE, an RRC message including a trigger state list and a CSI report configuration that includes one or more CSI report sub-configurations. The BS may further transmit, to the UE, a DCI format indicating a trigger state in the trigger state list, thereby enabling the UE to apply a subset of CSI report sub-configurations in the one or more CSI report sub-configurations to perform a CSI reporting procedure on a PUSCH, where the trigger state may be associated with the CSI report configuration and indicate the subset of CSI report sub-configurations.

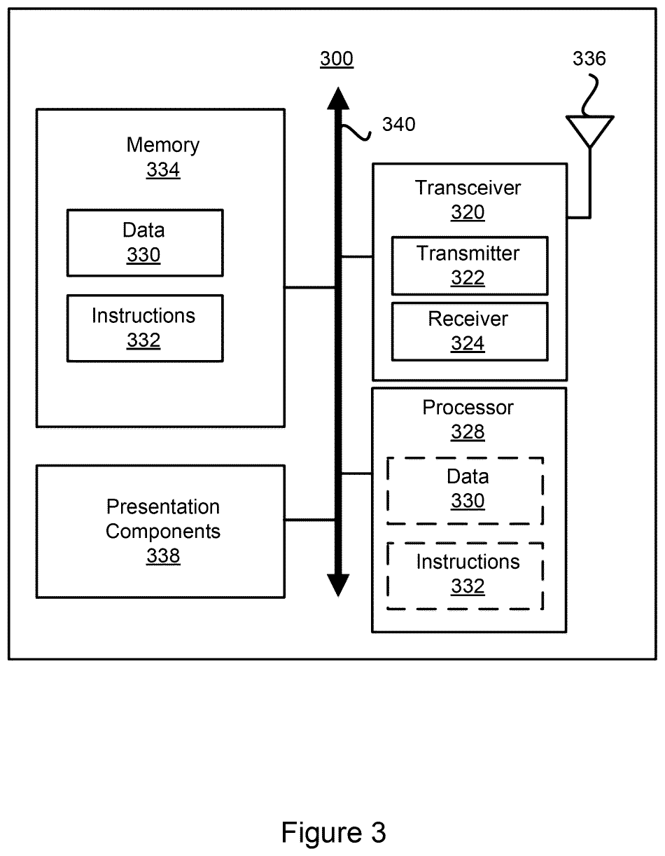

FIG. 3 is a block diagram illustrating node 300 for wireless communications, in accordance with various aspects of the present disclosure. As illustrated in FIG. 3, node 300 may include transceiver 320, processor 328, memory 334, one or more presentation components 338, and at least one antenna 336. Node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. Node 300 may be a UE or a BS that performs various functions disclosed with reference to FIGS. 1 through 2.

Transceiver 320 has transmitter 322 (e.g., transmitting/transmission circuitry) and receiver 324 (e.g., receiving/reception circuitry) and may be configured to transmit and/or receive time and/or frequency resource partitioning information. Transceiver 320 may be configured to transmit in different types of subframes and slots including, but not limited to, usable, non-usable, and flexibly usable subframes and slot formats. Transceiver 320 may be configured to receive data and control channels.

Node 300 may include a variety of computer-readable media. Computer-readable media may be any available media that may be accessed by node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the aforementioned listed components should also be included within the scope of computer-readable media.

Memory 334 may include computer-storage media in the form of volatile and/or non-volatile memory. Memory 334 may be removable, non-removable, or a combination thereof. Example memory may include solid-state memory, hard drives, optical-disc drives, etc. As illustrated in FIG. 3, memory 334 may store a computer-readable and/or computer-executable instructions 332 (e.g., software codes) that are configured to, when executed, cause processor 328 to perform various functions disclosed herein, for example, with reference to FIGS. 1 through 2. Alternatively, instructions 332 may not be directly executable by processor 328 but may be configured to cause node 300 (e.g., when compiled and executed) to perform various functions disclosed herein.

Processor 328 (e.g., having processing circuitry) may include an intelligent hardware device, e.g., a Central Processing Unit (CPU), a microcontroller, an ASIC, etc. Processor 328 may include memory. Processor 328 may process data 330 and instructions 332 received from memory 334, and information transmitted and received via transceiver 320, the baseband communications module, and/or the network communications module. Processor 328 may also process information to send to transceiver 320 for transmission via antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for enhancing Network Energy Saving (NES), the method comprising:
receiving, from a Base Station (BS), a Radio Resource Control (RRC) message comprising a trigger state list and a Channel State Information (CSI) report configuration that comprises one or more CSI report sub-configurations;
receiving, from the BS, a Downlink Control Information (DCI) format indicating a trigger state in the trigger state list, wherein the trigger state is associated with the CSI report configuration and indicates a subset of CSI report sub-configurations in the one or more CSI report sub-configurations; and
applying the subset of CSI report sub-configurations to perform a CSI reporting procedure on a Physical Uplink Shared Channel (PUSCH).

2. The method of claim 1, wherein the CSI report configuration is associated with one or more CSI Reference Signal (CSI-RS) resources and one or more CSI-RS antenna ports, and a CSI report sub-configuration in the subset of CSI report sub-configurations comprises at least one of the following:
a first field indicating a sub-configuration Identifier (ID),
a second field indicating a subset of CSI-RS resources in the one or more CSI-RS resources that is configured for a channel measurement, or
a third field indicating a subset of CSI-RS antenna ports in the one or more CSI-RS antenna ports.

3. The method of claim 2, wherein the third field comprises a bit string and each bit in the bit string corresponds to a CSI-RS antenna port of the one or more CSI-RS antenna ports, the method further comprising:
in response to determining that a bit in the bit string is set to a first value, enabling a CSI-RS antenna port that corresponds to the bit for calculating CSI in the CSI reporting procedure; and
in response to determining that the bit in the bit string is set to a second value, disabling the CSI-RS antenna port corresponding to the bit for calculating the CSI in the CSI reporting procedure.

4. The method of claim 3, further comprising:
identifying the subset of CSI-RS antenna ports according to the third field by determining which bits in the bit string are set to the first value.

5. The method of claim 1, wherein the CSI report configuration further comprises a first field indicating a report Identifier (ID) and a second field indicating the one or more CSI report sub-configurations.

6. The method of claim 1, wherein the CSI reporting procedure is one of an Aperiodic CSI (A-CSI) reporting procedure and a Semi-Persistent CSI (SP-CSI) reporting procedure.

7. A User Equipment (UE) for enhancing Network Energy Saving (NES), the UE comprising:
at least one processor; and
at least one non-transitory computer-readable medium coupled to the at least one processor and storing one or more computer-executable instructions that, when executed by the at least one processor, cause the UE to:
receive, from a Base Station (BS), a Radio Resource Control (RRC) message comprising a trigger state list and a Channel State Information (CSI) report configuration that comprises one or more CSI report sub-configurations;
receive, from the BS, a Downlink Control Information (DCI) format indicating a trigger state in the trigger state list, wherein the trigger state is associated with the CSI report configuration and indicates a subset of CSI report sub-configurations in the one or more CSI report sub-configurations; and
apply the subset of CSI report sub-configurations to perform a CSI reporting procedure on a Physical Uplink Shared Channel (PUSCH).

8. The UE of claim 7, wherein the CSI report configuration is associated with one or more CSI Reference Signal (CSI-RS) resources and one or more CSI-RS antenna ports, and a CSI report sub-configuration in the subset of CSI report sub-configurations comprises at least one of the following:
a first field indicating a sub-configuration Identifier (ID),
a second field indicating a subset of CSI-RS resources in the one or more CSI-RS resources that is configured for a channel measurement, or
a third field indicating a subset of CSI-RS antenna ports in the one or more CSI-RS antenna ports.

9. The UE of claim 8, wherein the third field comprises a bit string and each bit in the bit string corresponds to a CSI-RS antenna port of the one or more CSI-RS antenna ports, the one or more computer-executable instructions, when executed by the at least one processor, further causing the UE to:
in response to determining that a bit in the bit string is set to a first value, enable a CSI-RS antenna port that corresponds to the bit for calculating CSI in the CSI reporting procedure; and
in response to determining that the bit in the bit string is set to a second value, disable the CSI-RS antenna port corresponding to the bit for calculating the CSI in the CSI reporting procedure.

10. The UE of claim 9, wherein the one or more computer-executable instructions, when executed by the at least one processor, further cause the UE to:
identify the subset of CSI-RS antenna ports according to the third field by determining which bits in the bit string are set to the first value.

11. The UE of claim 7, wherein the CSI report configuration further comprises a first field indicating a report Identifier (ID) and a second field indicating the one or more CSI report sub-configurations.

12. The UE of claim 7, wherein the CSI reporting procedure is one of an Aperiodic CSI (A-CSI) reporting procedure and a Semi-Persistent CSI (SP-CSI) reporting procedure.

13. A Base Station (BS) for enhancing Network Energy Saving (NES), the BS comprising:
at least one processor; and
at least one non-transitory computer-readable medium coupled to the at least one processor and storing one or more computer-executable instructions that, when executed by the at least one processor, cause the BS to:
transmit, to a User Equipment (UE), a Radio Resource Control (RRC) message comprising a trigger state list and a Channel State Information (CSI) report configuration that comprises one or more CSI report sub-configurations; and
transmit, to the UE, a Downlink Control Information (DCI) format indicating a trigger state in the trigger state list, thereby enabling the UE to apply a subset of CSI report sub-configurations in the one or more CSI report sub-configurations to perform a CSI reporting procedure on a Physical Uplink Shared Channel (PUSCH),
wherein the trigger state is associated with the CSI report configuration and indicates the subset of CSI report sub-configurations.

14. The BS of claim 13, wherein the CSI report configuration is associated with one or more CSI Reference Signal (CSI-RS) resources and one or more CSI-RS antenna ports, and a CSI report sub-configuration in the subset of CSI report sub-configurations comprises at least one of the following:
a first field indicating a sub-configuration Identifier (ID),
a second field indicating a subset of CSI-RS resources in the one or more CSI-RS resources that is configured for a channel measurement, or
a third field indicating a subset of CSI-RS antenna ports in the one or more CSI-RS antenna ports.

15. The BS of claim 14, wherein the third field comprises a bit string and each bit in the bit string corresponds to a CSI-RS antenna port of the one or more CSI-RS antenna ports.

16. The BS of claim 13, wherein the CSI report configuration further comprises a first field indicating a report Identifier (ID) and a second field indicating the one or more CSI report sub-configurations.
